(19) United States
(12) Patent Application Publication
(10) Pub. No.: US 2005/0157603 A1
(43) Pub. Date: Jul. 21, 2005

(54) METHOD AND APPARATUS FOR IMPROVED SEEK PERFORMANCE AND STABILITY IN A HEADER-INCLUDED LAND/GROOVE OPTICAL DISC

(76) Inventors: Chih-Yuan Tseng, Hsin-Chu Hsien (TW); Shun-Yung Wang, Chu-Pei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,859

(22) Filed: Jan. 19, 2004

(51) Int. Cl. G11B 7/085

(52) U.S. Cl. 369/30.14

(57) ABSTRACT

An optical disc drive utilized for transferring data to and/or from a header-included land/groove optical disc includes a motor, a spindle, a focusing lens, a laser, a pickup head, a memory, and a control circuit. A header position signal is utilized as a mask to eliminate false track readings produced by passing headers in a track count signal, improving track count and allowing more precise control over the accelerative and braking radial forces applied to the pickup head during a jump. Additionally, the memory includes computer code to delay initiating and/or ending a jump when passing headers may interfere with normal seek operations and may prevent some jumps in the immediate vicinity of an upcoming G/L Switch Line.

### BACKGROUND OF INVENTION

1. Field of the Invention

This invention relates generally to an optical disc drive and more specifically to improving performance and stability during seek operations performed by the optical disc drive when utilizing a header-included land/groove optical disc.

2. Description of the Prior Art

Optical discs have become a preferred data storage medium due to their ease of use, low cost, portability, and capacity. Many types of optical discs enjoy wide usage in todays technologically savvy society. Rapid advancements in the art have led from read-only CDs to rewriteable CDs to read-only DVDs to various forms of rewriteable DVDs at a cost enabling widespread application. Due to efforts to squeeze more and more data onto a single optical disc coupled with the desire to improve rewritability of these high-density optical discs, recent innovation has developed header-included land/groove optical discs. Header-included land/groove optical discs, such as DVD-RAM, provide high capacity random access data storage having a structure and such highly refined phase-change materials that rewrites of up to 100,000 times are claimed possible.

FIG. 1 illustrates a conventional optical disc drive 10 utilized for transferring data to and/or from a header-included land/groove optical disc 11. The optical disc 11 would usually be enclosed within a protective casing, but the casing is not shown in FIG. 1 for simplicity. Normally interfaced with a host system 26, the optical disc drive 10 comprises a control circuit 18, a memory 20, a motor 12 and spindle 14, and an optical pickup head 16. The pickup head 16 comprises one or more lasers for emitting light beams for forming an optical spot on the optical disc 11 via a focusing lens 28 and further comprises optical sensors for generating signals according to the emitted light reflected from the optical disc 11. The control circuit 18 utilizes programs and data stored in the memory 20 to control operations of the optical disc drive 10 and for processing the generated signals according to system demands and/or requests from the host 26. The optical disc 11 comprises both a land track 24 and a groove track 22 and data may be written in either or both locations.

During read or write operations, the motor 12 spins the spindle 14 which rotates the optical disc 11 at substantially constant linear velocity across the pickup head 16 allowing data to be written to, or read from, a single track 22, 24 of the optical disc 11. Additionally, the pickup head 16 is moveably mounted within the optical disc drive 10 permitting radial movement relative to the optical disc 11. Radial movement of the pickup head 16 allows following a single track 22, 24 as the track 22, 24 spirals outward from the center of the optical disc 11 and also permits a jump from one track 22, 24 to a different track 22, 24 according to system requirements.

A tracking error signal, generated from outputs of the optical sensors in the pickup head 16, is utilized by the control circuit 18 to keep the pickup head 16 optimally positioned for reading from or writing to a specific track 22, 24 and for facilitating jumps from one track 22, 24 to another track 22, 24 by providing a means for counting the number of tracks 22, 24 crossed during the jump. Because of the physical differences in contour between a land track 24 and a groove track 22, the polarity of the tracking error signal reverses each time a switch is made from a land track 24 to a groove track 22 or from a groove track 22 to a land track 24. Although the optical disc 11 normally comprises a single pair of one land track 24 and one groove track 22, throughout this disclosure a reference to a number of tracks jumped or crossed when discussing jumps is intended to mean the number of times that the optical spot changes from a land track 24 to a groove track 22 and from a groove track 22 to a land track 24 due to radial motion of the pickup head during a seek operation.

Please refer to FIG. 2, which illustrates a portion of the optical disc 11 notated in FIG. 1 by the circle marked A. In FIG. 2, the alternating land 24 and groove 22 tracks are indicated by the letters L (for land 24) and G (for groove 22). As can be seen, the optical disc 11 is radially segmented (within predefined zones) by a plurality of headers regularly spaced (within each zone) around the optical disc 11. Each header has 2080 channel bits and the period between headers has 41,072 channel bits. With a constant linear velocity of 1×, it takes approximately 72 us and 1416 us respectively for a header and the tracks 22, 24 between two adjacent headers to move across the pickup head 16.

Each header comprises a data address and information indicating whether a land track 24 or a groove track 22 immediately follows that header. User data is not recorded in the header, but instead is recorded in the land 24 or groove 22 track between two adjacent headers. One of the headers is also known as a G/L Switch Line. The only difference between the G/L Switch Line and the other headers is that immediately following the G/L Switch Line, the land tracks 24 and the groove tracks 22 are switched as shown in FIG. 2. For example, if a given track preceding the G/L Switch Line is a land track 24, after the G/L Switch Line the same track becomes a groove track 22. If a given track preceding the Switch Line is a groove track 22, after the G/L Switch Line the same track becomes a land track 24. Because of the possible reversal of polarity in the tracking error signal, foreknowledge of the type of track (i.e. land 24 or groove 22) that is to be read next is of paramount importance for ensuring proper operation of the optical disc drive 10.

During a normal read/write operation, the headers, including the G/L Switch Line, provide track type information as the pickup head 16 simply follows the current track 24, 22 spiraling around the optical disc 11. However, from time to time, system requirements necessitate a seek operation, meaning a jump in a radial direction from the current track 22, 24 to a different track 22, 24 on the optical disc 11. While the headers are vital during a read/write operation, during a jump it is possible and often probable that the headers will not be read properly, causing seek errors, improper polarity, or instability in the operation of the optical disc drive 10.

A first prior art problem occurs during a jump of only one or a few tracks 22, 24. Here, because the number of tracks 22, 24 being jumped is quite small, an error in the counting of jumped tracks 22, 24 or inaccurate knowledge of the polarity of the target track 22, 24 can lead to seek failure. FIG. 3 is a graph illustrating such a scenario. The tracking error signal (TE) is shown across the top of the graph. Across the upper center of the graph is a TRSO signal. The TRSO signal indicates the amount of accelerative or braking force being applied to the pickup head 16 to move the pickup head 16 from one track 22, 24 to another in a radial direction.

Conventionally, a digitized tracking error zero crossing (TEZC) signal has been used to generate a track count signal to count the number of tracks 22, 24 crossed during a jump. Accuracy in track count is important not only to determine the location of the target track but also is necessary to properly control the TRSO signal so that the optical spot will stop radial movement precisely on the target track 22, 24.

Across the lower center of the graph is shown a digitized pseudo radio frequency zero crossing (PRFZC) signal that is inverted when the TE reaches a local maximum and a local minimum. It may also be possible to use the PRFZC signal as a track count signal and to control the TRSO signal. For greater accuracy, it is preferred (but not necessary) to use a combination of the TEZC and PRFZC signals to generate the track count signal. A detailed description of utilizing a combination of the TEZC and PRFZC signals can be found in U.S. patent application Ser. No. 10/065,659, herein incorporated by reference.

Across the bottom of the graph is header position signal (HDPOS) that indicates when a header is passing across the optical spot generated by the laser in the pickup head 16. A passing header temporarily disrupts the TE as can be seen at the corresponding points labeled as N. In this example, the jump is initiated at point S and is concluded at point E on the graph.

As is shown by the HDPOS, a header passes across the optical spot during the jump at point H. The passing header disrupts the TE as usual, but this time, because it occurs during a jump and the TE is being used to generate the track count signal, the optical disc drive 10 cannot properly control the TRSO to stop the pickup head 16 on the target track 22, 24, resulting in seek failure. As a result, an additional jump will be required to finally get to the target track 22, 24.

A second prior art problem may also occur during a jump of any number of tracks 22, 24. Please refer to FIG. 4, which illustrates the trouble. As stated, during the jump the TE is digitized to produce the track count signal, which is used to count the number of tracks 22, 24 crossed and also used to control the TRSO so that during the jump, the proper radial force is applied to the pickup head 16 to seek and stop at the target track 22, 24. However, in a jump of more than a few tracks 22, 24, one or more headers necessarily will pass across the optical spot during the jump. In FIG. 4, passing headers are indicated by the HDPOS signal, which is a digitized version of a Header Indication Signal (HIS) generated by the optical sensors in the pickup head 16. These headers disrupt the TE (as shown at points N) producing false readings in the track count signal at the location of each header.

The false readings in the track count signal can result in two problems. First, because the track count signal is utilized to count the number of tracks 22, 24 being crossed during the jump, false readings may make the track count incorrect and thus the pickup head will not stop on the target track 22, 24. A second problem resulting from false readings in the track count signal is that the control circuit 18, to control the TRSO, utilizes the amount of time between the state changes in the track count signal. When false readings appear in the track count signal, the TRSO cannot be controlled correctly, and again, the pickup head 16 will not stop on the target track 22, 24, resulting in seek failure. During longer jumps, a large number of headers may pass beneath the optical spot produced by the pickup head 16 resulting in missing the target track 22, 24 by enough tracks 22, 24 to require another long jump, consequentially leading to system instability.

A third prior art problem can arise at the end of a jump. If a header passes across the optical spot at the same time as the optical spot first reaches the target track as shown in FIG. 5, the disrupted TE again makes it impossible to properly control the TRSO and seek failure ensues.

A fourth prior art problem can arise if a G/L Switch Line passes across the optical spot after a jump has substantially finished and before the TE has re-stabilized. Because the G/L Switch Line necessitates a reversal in polarity of the TE and, because the TE has not yet re-stabilized, it may be impossible to properly read the switched polarity information in the passing G/L Switch line, resulting in the inability to properly read the ensuing track 22, 24.

### SUMMARY OF INVENTION

It is therefore a primary objective of the claimed invention to provide a device and method for improving performance and stability during seek operations when utilizing a header-included land/groove optical disc.

According to the present invention, an optical disc drive utilized for transferring data to and/or from a header-included land/groove optical disc comprises a motor and a spindle for rotating the optical disc across a focusing lens of a pickup head. The pickup head includes one or more lasers for emitting light through the focusing lens to the optical disc for forming an optical spot on the optical disc and further includes optical sensors for generating signals according to the emitted light reflected from the optical disc. A memory and control circuit are also comprised by the optical disc drive, which may be interfaced with a host computer system. The memory may be any form of RAM, ROM, or Flash and may be either volatile or non-volatile in nature and comprises computer code and data utilized by the control circuit for controlling operations of the optical disc drive according to the various aspects of the present invention.

One aspect of the present invention includes seek related computer code that compares the number of tracks to be jumped with a predetermined quantity. If the number of tracks to be jumped does not exceed the predetermined quantity, the control circuit delays the jump until after the next header has been read and the TE signal has re-stabilized allowing the jump to be conducted between adjacent headers.

Another aspect of the present invention includes seek related computer code that utilizes a header position signal as a mask to eliminate false track readings produced by passing headers in a track count signal, substantially improving accuracy in track count and allowing the control circuit to more precisely control the accelerative and braking forces applied to the pickup head during a jump.

Another aspect of the present invention includes seek related computer code that delays continuing normal operations at the end of a jump when the jump lands on a passing header. In this situation, normal operations are delayed until after the header has passed the optical spot. Once the header is no longer under the optical spot, normal read/write operations can continue.

Another aspect of the present invention includes seek related computer code that establishes a Danger Zone, preventing jumps in the vicinity of an upcoming G/L Switch Line. If a jump is required while a portion of the Danger Zone of the optical disc is crossing the optical spot, the jump may be delayed until after the Danger Zone has passed the optical spot and the G/L Switch Line has been read.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 illustrates a conventional optical disc drive capable of utilizing a header-included land/groove optical disc.

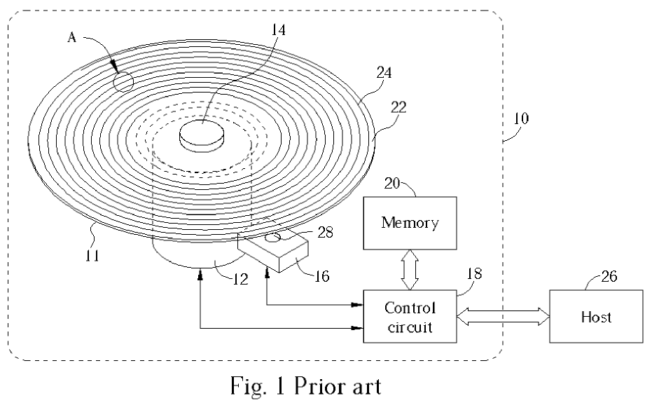

FIG. 2 illustrates a portion of a header-included land/groove optical disc utilized by the optical disc drive of FIG. 1.

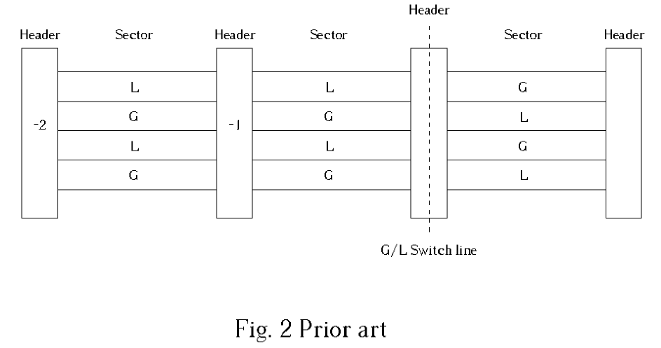

FIG. 3 is a signal diagram illustrating seek failure during a short jump.

FIG. 4 is a signal diagram illustrating false readings during a jump.

FIG. 5 is a signal diagram illustrating seek failure at the end of a jump.

FIG. 6 illustrates an optical disc drive capable of utilizing a header-included land/groove optical disc according to the present invention.

FIG. 7 is a graph illustrating a jump not exceeding MAXTRACKS according to the present invention.

FIG. 8 illustrates the effect of using the HDPOS as a mask to remove the effect of passing headers from the PRFZC.

FIG. 9 illustrates the TE, TRSO, and the HDPOS at the end of a jump according to the present invention.

FIG. 10 shows an example portion of a header-included land/groove optical disc.

FIG. 11 is a flow chart demonstrating one possible implementation of the present invention.

FIG. 12 is a flow chart demonstrating another possible implementation of the present invention.

### DETAILED DESCRIPTION

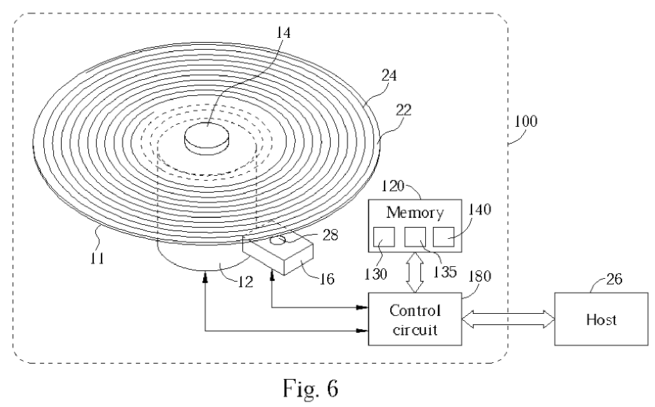

Please refer to FIG. 6, which illustrates an optical disc drive 100 according to the present invention. The optical disc drive 100 is utilized for transferring data to and/or from a header-included land/groove optical disc 11, such as a an optical disc 11 conforming to an industry standard DVD-RAM specification. The optical disc drive 100 comprises a motor 12 and a spindle 14 for rotating the optical disc 11 across a focusing lens 28 of a pickup head 16. The pickup head 16 includes one or more lasers for emitting light through the focusing lens 28 to form an optical spot on the optical disc 11 and further includes optical sensors for generating signals according to the emitted light reflected from the optical disc 11. A memory 120 and control circuit 180 are also comprised by the optical disc drive 100, which is usually but not necessarily interfaced with a host computer system 26. Components of the optical disc drive 100 that are the same as components in the optical disc drive 10 use the same reference numbers and further description of these similar components is omitted here for simplicity.

One major difference between the prior art optical disc drive 10 and the optical disc drive 100 is the memory 120. The memory 120 may be any form of RAM, ROM, or Flash and may be either volatile or non-volatile in nature. The memory 120 comprises computer code, thresholds, and data utilized by the control circuit 18 for controlling operations of the optical disc drive 100 according to the various aspects of the present invention as described below.

One embodiment of the present invention includes seek related computer code that eliminates the first prior art problem of a header passing across the optical spot during a jump of only 1 or a few tracks 22, 24. While the exact maximum number of tracks 22, 24 jumped in this situation may be subject to response speeds and other design considerations, this aspect of the present invention is directed toward a jump that can be initiated and concluded between adjacent headers, or less than approximately 1416 us at 1× speed. It is preferred but not necessary that the jump be initiated after the TE has re-stabilized. Obviously, a higher Xn speed would reduce the time available between headers and thus may also reduce the maximum number of tracks that can be jumped within the allotted time. However, a threshold called MAXTRACKS can be determined by experimentation, design considerations, or calculated on the fly, which represents this maximum number of tracks for any given rotational speed and/or differing makes and models of the optical disc drive 100.

According to this embodiment, when the optical disc drive 100 determines that a jump is necessary, the control circuit 180 compares the number of tracks 22, 24 to be jumped with MAXTRACKS. If the number of tracks 22, 24 to be jumped does not exceed MAXTRACKS, then the control circuit 180 delays the jump by the First Delay until after the next header has been read and the TE signal has re-stabilized. The First Delay allows the entire jump to be conducted between adjacent headers, eliminating any false readings in the PRFZC due to passing headers. The threshold MAXTRACKS and/or associated First Delay computer code can be part of the computer code 130 comprised by the memory 120.

Although it is possible to delay every jump until after the next header has passed the optical spot, to speed seek operations of the optical disc drive 100 it is preferred that the First Delay is only implemented when the number of tracks to be jumped does not exceed MAXTRACKS. In a jump longer than MAXTRACKS, missing the target track 22, 24 by one or a few tracks due to false readings in the TE caused by a passing header generally does not significantly add to instability. However, in jumps not exceeding MAXTRACKS, missing the target track 22, 24 by even one track 22, 24 essentially necessitates repetition of the entire jump. Therefore, in jumps not exceeding MAXTRACKS, substantial gains in stability can be gained by delaying the start of the jump until after the next header has been read. Note that the duration of the First Delay is not fixed. The First Delay is of whatever duration is necessary beginning at the particular point in time that the optical disc drive 100 determines that a jump not exceeding MAXTRACKS is necessary to allow the next header to cross the optical spot and the TE to re-stabilize.

A predetermined duration of the portion of the First Delay necessary to allow re-stabilization of the TE may be determined experimentally. It may also be possible for the control circuit 180 to simply end the First Delay after the TE has substantially re-stabilized after encountering a passing header. What is important is that the jump is delayed until the next header has passed the optical spot and the TE has re-stabilized.

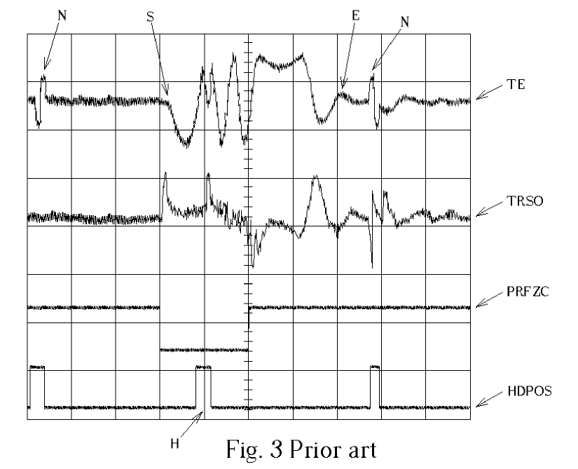

FIGS. 3, 4, 7, and 8 accompanying this disclosure include example PRFZC signals to aid in the understanding of various aspects of the present invention because it is possible that those skilled in the art may not be as familiar with the PRFZC signal as the same artisans would be familiar with the conventional TECZ signal. However, a track count signal generated according to the TEZC signal, generated according to the PRFZC signal, or generated utilizing both the TECZ and PRFZC signals all are intended to fall within the scope of the present invention.

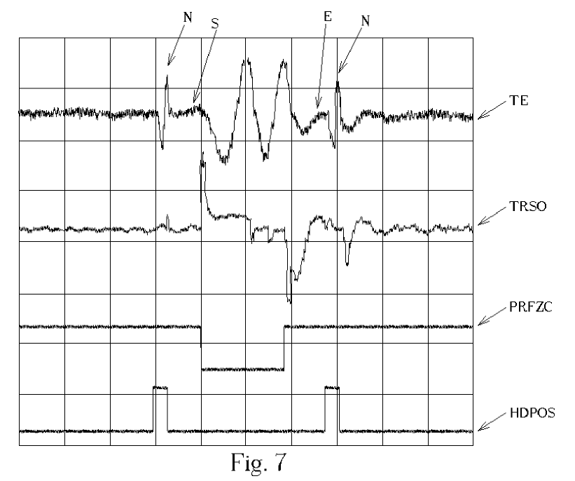

FIG. 7 illustrates a graph illustrating such a scenario. The graph shows example TE, TRSO, PRFZC, and HDPOS signals during a jump not exceeding MAXTRACKS when the jump has been delayed until after TE re-stabilization following the next header. When compared with the prior art implementation illustrated in FIG. 3, it is clear that utilizing the First Delay aspect of the present invention offers greater stability and control of the TRSO, resulting in fewer seek errors.

Another embodiment of the present invention includes seek related computer code that eliminates the second prior art problem of a header passing across the optical spot during a jump. During a jump the track count signal is used to count the number of tracks 22, 24 crossed and also used to control the TRSO so that, during the jump, the proper radial force is applied to the pickup head 16 to seek and stop at the target track 22, 24. However, headers disrupt the TE producing false readings in the track count signal at the location of each header. As stated, the false readings in the track count signal can result in two problems: inaccurate counting of tracks 22, 24 crossed during the jump and improper control of the TRSO resulting in seek failure.

One of the signals generated by the optical sensors in the pickup head 16 is a Header Indication Signal (HIS), which obviously indicates whether a header is currently passing across the optical spot. The HIS is digitized to produce the HDPOS. This embodiment of the present invention eliminates the second prior art problem of a header passing across the optical spot during a jump by using the HDPOS signal as a mask against the track count signal, having the effect of removing the HDPOS influence from the track count signal. This eliminates false readings in the track count signal due to passing headers. It may be possible to use the HIS against the TE before generating the track count signal without departing from the spirit of the invention, however using the HDPOS as a mask normally produces better results due to the respective natures of analog and digital signals. The key to this aspect of the present invention is utilizing the HDPOS (or HIS) to remove the effect of passing headers from the track count signal. The computer code necessary to implement this aspect of the present invention may be stored in area 135 of the memory 120.

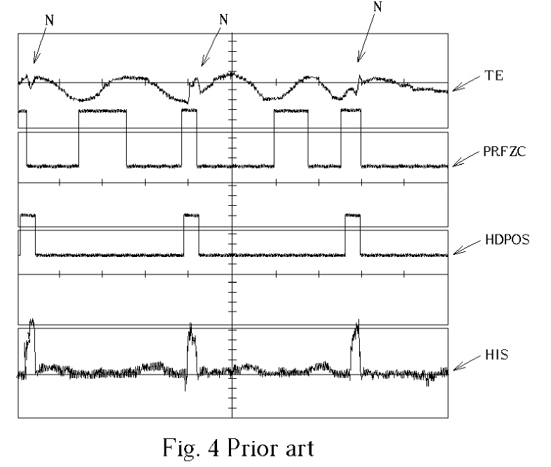

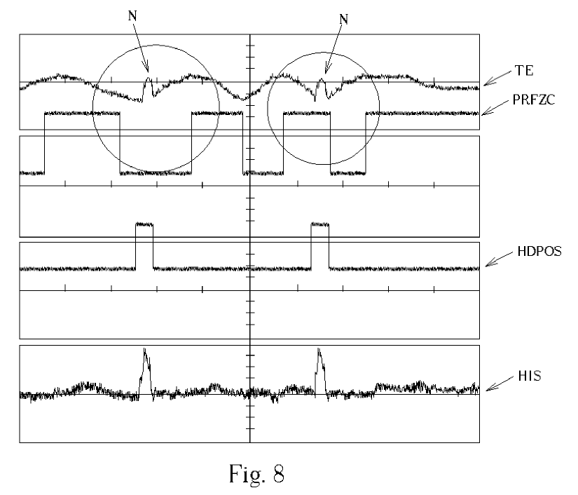

FIG. 8 illustrates the effect of using the HDPOS as a mask to remove the effect of passing headers from the track count signal (here, the PRFZC signal). Please compare this drawing with that of FIG. 4. FIG. 4 shows the prior art effect of headers on the PRFZC at the locations marked N. FIG. 8 shows the effect of headers (at the locations labeled N) on the PRFZC after the HDPOS has been used as a mask according to the present invention. In FIG. 8, clearly the false readings in the PRFZC produced by passing headers have been substantially eliminated.

The elimination of false readings in the track count signal due to passing headers has two immediate benefits for the optical disc drive 100. First, changes in state in the track count signal, indicated by rising and falling edges in the signal, indicate a change from one track 22, 24 to another. Because the false readings have been eliminated from the track count signal utilized to count the number of tracks 22, 24 being crossed during the jump, the track count is more precise, increasing the chance of the pickup head 16 stopping on the target track 22, 24. Secondly, the time between edges in the track count signal corresponds more directly to the time taken to cross from one track 22, 24 to another, allowing the control circuit 18 to control the TRSO with much more precision, reducing or eliminating seek errors.

Another embodiment of the present invention includes seek related computer code that deals with the third prior art problem arising if a header passes across the optical spot before the TE has stabilized at the end of a jump. In this embodiment, at the end of a jump, if the optical spot lands on a passing header, the control circuit 180 waits a Second Delay until the passing header is no longer within the optical spot before beginning normal read/write operations. Additionally, the HDPOS optionally may be used to mask out the disruptive effects to the TE of the passing header as in the previous embodiment allowing more precise control of the TRSO so that the radial movement of the pickup head 16 stops as required at the end of the jump.

When the target track has been first reached during a jump and at least a portion of a passing header is within the optical spot, the control circuit 180 initiates the Second Delay duration to ensure that the passing header is no longer within the optical spot before continuing normal operations. As with the First Delay, the duration of the Second Delay is variable according to current conditions and not fixed, although a fixed Second Delay, for example the amount of time necessary to guarantee that the passing header has left the optical spot does not vary from the spirit of the invention. The important aspect of this embodiment is that the Second Delay delays normal read/write operations if a passing header is within the optical spot when the optical spot first reaches the target track 22, 24. The computer code to implement the Second Delay may be stored in area 135 or elsewhere in the memory 120.

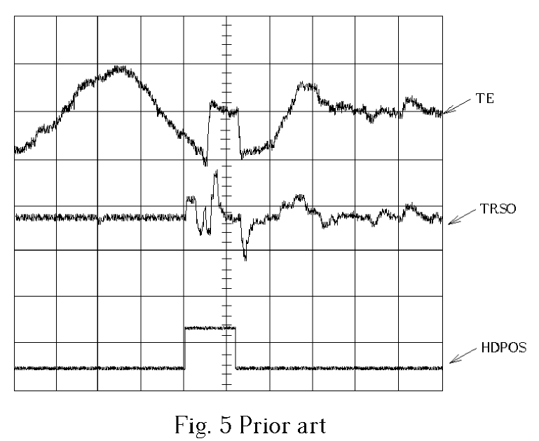

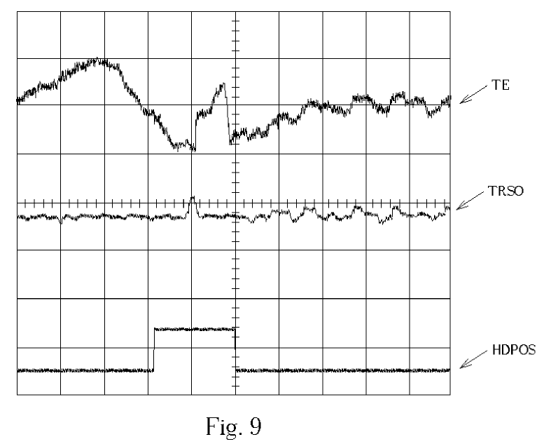

The Second Delay begins when at least a portion of a header is within the optical spot at the same time that the control circuit determines that the target track 22, 24 may have been reached and may end after the header is no longer within the optical spot. FIG. 9 illustrates the TE, TRSO, and the HDPOS at the end of an example jump when implementing this embodiment of the present invention. Please compare the TRSO after the header in FIG. 9 with the prior art post header TRSO shown in FIG. 5. Again, the present invention results in better control of the TRSO and therefore results in better performance and stability at the end of a jump.

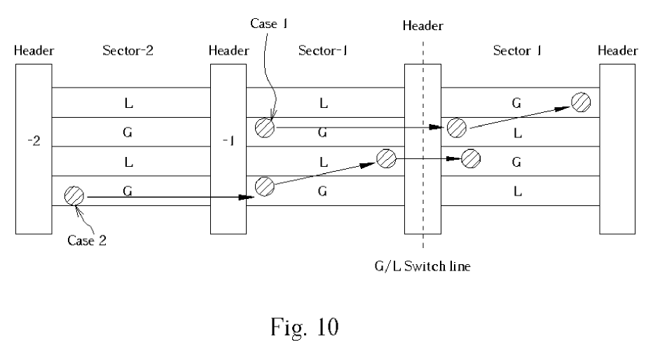

Another embodiment of the present invention includes seek related computer code that eliminates the fourth prior art problem of a G/L Switch Line passing across the optical spot between the end of a jump and re-stabilization of the TE. FIG. 10 shows an example portion of a header-included land/groove optical disc. In FIG. 10, land tracks 24 and groove tracks 22 are denoted by an L or a G respectively. Four headers are shown as are the three sectors separating the four headers. One of the headers is a G/L Switch Line where the track types are reversed as shown.

The optical spots labeled as Case 1 illustrate a successful jump. Here, the jump is delayed until after reading the next header (the next header in this case is the G/L Switch Line), then, the jump is made. Because the G/L Switch Line has been read informing the control circuit 180 of the upcoming polarity switch in the TE, the proper polarity of the target track (a groove) can be determined allowing for proper utilization of the target track.

However, the optical spots associated with Case 2 in FIG. 10 illustrate the fourth prior art problem. Here, the jump is delayed until after the next header (labeled 1) has been read and the TE has re-stabilized, then, the jump is made. As is shown, the pickup head 16 is moved so that the optical spot moves to the target track (a land) just before encountering the following header (the G/L Switch Line). If the control circuit 180 is unable to properly read the G/L Switch Line because generated signals have not yet re-stabilized after the jump, the control circuit 180 will improperly still assume that the target track is a land track 22 because a land track was anticipated as the target track. Without knowledge that a G/L Switch Line has been crossed, incorrect TE polarity results in the inability to properly read the target track following the G/L Switch Line.

Therefore, this embodiment of the present invention establishes a Danger Zone, preventing jumps in the vicinity of an upcoming G/L Switch Line with the introduction of a Third Delay. As with the First and Second Delays, the duration of the Third Delay depends upon current conditions. The exact physical distance on the optical disc covered by the Danger Zone can be determined by experimentation, however, it is preferred to include at least the sector immediately preceding each upcoming G/L Switch Line. For example, in FIG. 10, the Danger Zone may include everything between the header labeled as 1 and the G/L Switch Line, inclusive. If a jump is required while a portion of the Danger Zone of the optical disc 11 is crossing the optical spot, the jump is delayed until after the Danger Zone has passed the optical spot and the G/L Switch Line has been read. The computer code to implement the Danger Zone and/or Third Delay may be stored in area 140 or elsewhere in the memory 120.

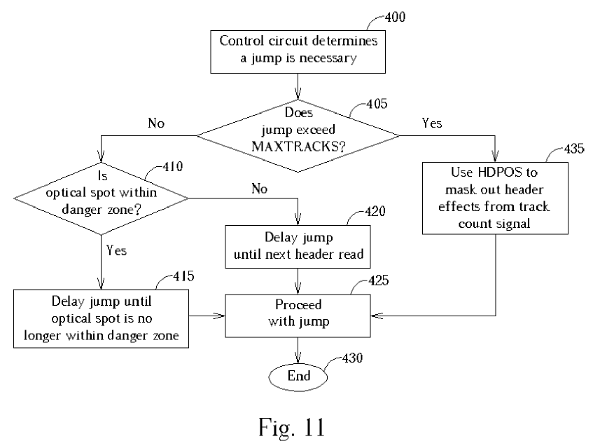

FIG. 11 is a flow chart demonstrating one possible implementation of the present invention.

Step 400: The control circuit 180 has determined that a jump is necessary. Go to Step 405.

Step 405: If the number of tracks in the necessary track does not exceed MAXTRACKS, go to Step 410. If the number of tracks in the necessary jump exceeds MAXTRACKS, go to Step 435.

Step 410: If the optical spot on the optical disc 11 is within the Danger Zone, go to Step 415. If the optical spot on the optical disc 11 is not within the Danger Zone, go to Step 420.

Step 415: Delay the jump by the Third Delay until the Danger Zone has passed the optical spot produced by the operating laser in the pickup head 16. Go to Step 425.

Step 420: Delay the jump by the First Delay until the next header has been read and the TE re-stabilized. Go to Step 425.

Step 425: Proceed with jump. Go to Step 430.

Step 430: End jump. Note that the implementation of the Second Delay may optionally be part of Step 430.

Step 435: Use HDPOS to mask out the effects of passing headers from the PRFZC. Go to step 425.

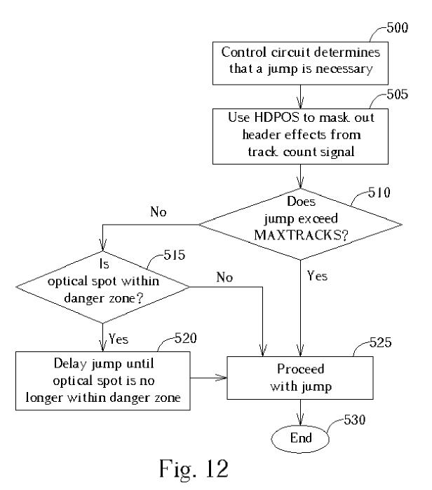

FIG. 12 is a flow chart demonstrating another possible implementation of the present invention.

Step 500: The control circuit 180 has determined that a jump is necessary. Go to Step 505.

Step 505: Use HDPOS to mask out the effects of passing headers from the PRFZC. Go to step 505.

Step 510: If the number of tracks in the necessary jump does not exceed MAXTRACKS, Go to Step 515. If the number of tracks in the necessary jump exceeds MAXTRACKS, go to Step 525.

Step 515: If the optical spot on the optical disc 11 is within the Danger Zone, go to Step 520. If the optical spot on the optical disc 11 is not within the Danger Zone, go to Step 525.

Step 520: Delay the jump by the Third Delay until the Danger Zone has passed the optical spot produced by the operating laser in the pickup head 16. Go to Step 525.

Step 525: End jump. Note that the implementation of the Second Delay may optionally be part of Step 525.

The present invention increases performance and stability in an optical disc drive by solving at least five seek related problems.

First, if a jump does not exceed MAXTRACKS, the jump is delayed for a First Delay, allowing the next header to be read, the TE to re-stabilize, and the entire jump to be conducted within a single sector.

Second, the use of the HDPOS to mask out the effects of passing headers from the track count signal substantially improves the accuracy in track count, improving seek accuracy.

Third, the use of the HDPOS to mask out the effects of passing headers from the track count signal allows the control circuit to more precisely control the accelerative and braking forces applied to the pickup head during a jump, substantially reducing the number of seek failures.

Fourth, utilizing a Second Delay at the end of a jump that lands on a header before continuing normal read/write operations increases stability in the optical disc drive.

Fifth, maintaining a Danger Zone in the vicinity immediately preceding a G/L Switch Line can prevent polarity problems that may occur at the end of some jumps.

Those skilled in the art will readily observe that numerous modifications and alterations of the device and method may be made while retaining the teachings of the invention. Other implementations using one or more aspects of the present invention are obviously possible. For example, not separating jumps exceeding MAXTRACKS from those that do not exceed MAXTRACKS can still yield significant improvements in performance and stability merely by masking out the effect of passing headers from the track count signal. Accordingly, the above disclosure should be construed as limited only by the metes and bounds of the appended claims.

1. A method for improving seek operations in an optical disc drive when utilizing a header-included land/groove optical disc, the optical disc drive having a pickup head comprising a laser for generating an optical spot on the optical disc and at least one optical sensor for generating signals according to light reflected from the optical spot, the method comprising:
generating a first signal indicating whether a header is currently passing across the optical spot;
generating a track count signal capable of indicating a change in position of the optical spot from a first track to a second track during a seek operation; and
utilizing the first signal as a mask against the track count signal to substantially mask out the effects of passing headers from the track count signal.

2. The method of claim 1 wherein after the first signal has been used as a mask, the method further comprises utilizing the track count signal to count the number of track changes during the seek operation.

3. The method of claim 1 wherein after the first signal has been used as a mask, the method further comprises utilizing the track count signal to control accelerative and braking forces applied radially to the pickup head during the seek operation.

4. The method of claim 1 wherein if the number of track changes in the seek operation does not exceed a predetermined threshold, the method further comprises initiating a First Delay to allow a next header to be read before initiating the first track change in the seek operation.

5. The method of claim 4 wherein the First Delay further allows a tracking error signal generated by the optical disc drive to substantially re-stabilize after the next header has been read before the first track change in the seek operation is initiated.

6. The method of claim 1 further comprising initiating a Second Delay if at least a portion of a passing header is within the optical spot when the optical spot first reaches a target track before reading or writing user data in the target track.

7. The method of claim 1 wherein if the optical spot is within a predetermined Danger Zone preceding a G/L Switch Line, the method further comprises initiating a Third Delay to allow the G/L Switch Line to be read before the first track change in the seek operation is initiated.

8. A method for improving stability in a seek operation in an optical disc drive when utilizing a header-included land/groove optical disc, the method comprising:
if the number of track changes in the seek operation does not exceed a predetermined threshold, initiating a First Delay to allow a next header to be read before the first track change in the seek operation is initiated.

9. The method of claim 8 wherein the First Delay further allows a tracking error signal generated by the optical disc drive to substantially re-stabilize after the next header has been read before the first track change in the seek operation is initiated.

10. The method of claim 8 wherein the predetermined threshold is equal to or less than the greatest number of tracks jumped in a seek operation that can be initiated and concluded between adjacent headers.

11. A method for improving stability a seek operation in an optical disc drive when utilizing a header-included land/groove optical disc, the optical disc drive comprising a laser for generating an optical spot on the optical disc and at least one optical sensor for generating signals according to light reflected from the optical spot, the method comprising:
initiating a Second Delay if at least a portion of a passing header is within the optical spot when the optical spot first reaches a target track before reading or writing user data in the target track.

12. The method of claim 11 further comprising:
generating a first signal indicating whether a header is currently passing across the optical spot;
generating a track count signal capable of indicating a change in position of the optical spot from a first track to a second track of the optical disc during the seek operation; and
utilizing the first signal as a mask against the track count signal to substantially mask out the effects of passing headers from the track count signal.

13. A method for improving stability in a seek operation in an optical disc drive when utilizing a header-included land/groove optical disc, the optical disc drive comprising a laser for generating an optical spot on the optical disc, the method comprising:
if the optical spot is within a predetermined Danger Zone preceding a G/L Switch Line, initiating a Third Delay to allow the G/L Switch Line to be read by the optical disc drive before the first track change in the seek operation is initiated.

14. The method of claim 13 wherein the Danger Zone comprises at least one physical sector of the optical disc immediately preceding the G/L Switch Line.

15. An optical disc drive utilized for transferring data to and/or from a header-included land/groove optical disc, the optical disc drive comprising:
a pickup head comprising:
a laser for emitting light through a focusing lens to form an optical spot on the optical disc; and
at least one optical sensor for generating signals according to the emitted light reflected from the optical spot; and
a memory comprising:
computer code for utilizing a first generated signal, the first generated signal indicating whether a header is currently passing across the optical spot;
computer code for utilizing a generated track count signal, the generated track count signal capable of indicating a change in position of the optical spot from a first track to a second track during a seek operation; and
computer code for utilizing the first generated signal as a mask against the generated track count signal to substantially mask out the effects of passing headers from the generated track count signal.

16. The optical disc drive of claim 15 wherein after the first generated signal has been used as a mask, the generated track count signal is utilized by the optical disc drive to count the number of track changes during the seek operation.

17. The optical disc drive of claim 15 wherein after the first signal has been used as a mask, the optical disc drive utilizes the generated track count signal to control accelerative and braking forces applied radially to the pickup head during the seek operation.

18. The optical disc drive of claim 15 wherein the memory further comprises a predetermined threshold that indicates a maximum number of track changes in a seek operation that can be initiated and concluded between adjacent headers on the optical disc.

19. The optical disc drive of claim 18 wherein the memory further comprises computer code for initiating a First Delay to allow a next header to be read before initiating the first track change in the seek operation if the number of track changes in the seek operation does not exceed the predetermined threshold.

20. The optical disc drive of claim 19 wherein the First Delay further allows a tracking error signal generated by the optical disc drive to substantially re-stabilize after the next header has been read before the first track change in the seek operation is initiated.

21. The optical disc drive of claim 15 wherein the memory further comprises computer code for initiating a Second Delay if at least a portion of a passing header is within the optical spot when the optical spot first reaches a target track before reading or writing user data in the target track.

22. The optical disc drive of claim 15 wherein the memory further comprises computer code for determining if the optical spot is within a predetermined Danger Zone preceding a G/L Switch Line on the optical disc.

23. The optical disc drive of claim 22 wherein the memory further comprises computer code for initiating a Third Delay if it is determined that the optical spot is within the predetermined Danger Zone to allow the G/L Switch Line to be read before the first track change in the seek operation is initiated.

24. The optical disc drive of claim 22 wherein the predetermined Danger Zone comprises at least one physical sector of the optical disc immediately preceding the G/L Switch Line.

25. An optical disc drive having improved stability in seek operations when utilizing a header-included land/groove optical disc, the optical disc drive comprising:
a memory comprising a predetermined threshold that indicates a maximum number of track changes in a seek operation that can be initiated and concluded between adjacent headers on the optical disc.

26. The optical disc drive of claim 25 wherein the memory further comprises computer code for initiating a First Delay to allow a next header to be read before initiating the first track change in the seek operation if the number of track changes in the seek operation does not exceed the predetermined threshold.

27. The optical disc drive of claim 26 wherein the First Delay further allows a tracking error signal generated by the optical disc drive to substantially re-stabilize after the next header has been read before the first track change in the seek operation is initiated.

28. The optical disc drive of claim 25 wherein the predetermined threshold is equal to or less than the greatest number of tracks jumped in a seek operation that can be initiated and concluded between adjacent headers.

29. An optical disc drive having improved stability in seek operations when utilizing a header-included land/groove optical disc, the optical disc drive comprising:
a memory comprising:
computer code capable of initiating a Second Delay if at least a portion of a passing header is within the optical spot when the optical spot first reaches a target track before reading or writing user data in the target track.

30. The optical disc drive of claim 29 wherein the optical disc drive further comprises a laser for emitting light to form an optical spot on the optical disc and at least one optical sensor for generating signals according to the emitted light reflected from the optical spot; and wherein the memory further comprises:
computer code for utilizing a first generated signal, the first generated signal indicating whether a header is currently passing across the optical spot;
computer code for utilizing a generated track count signal, the generated track count signal capable of indicating a change in position of the optical spot from a first track to a second track during the seek operation; and
computer code for utilizing the first generated signal as a mask against the generated track count signal to substantially mask out the effects of passing headers from the generated track count signal.

31. An optical disc drive utilized for transferring data to and/or from a header-included land/groove optical disc, the optical disc drive having a laser for emitting light to form an optical spot on the optical disc, the optical disc drive comprising:
a memory comprising computer code for determining if the optical spot is within a predetermined Danger Zone preceding a G/L Switch Line on the optical disc.

32. The optical disc drive of claim 31 wherein the memory further comprises computer code for initiating a Third Delay if it is determined that the optical spot is within the predetermined Danger Zone, the Third Delay allowing the G/L Switch Line to be read before the first track change in the seek operation is initiated.

33. The optical disc drive of claim 31 wherein the predetermined Danger Zone comprises at least one physical sector of the optical disc immediately preceding the G/L Switch Line.
